(19) United States
(12) Patent Application Publication
(10) Pub. No.: US 2012/0070516 A1
(43) Pub. Date: Mar. 22, 2012

(54) Mycotoxin binding food and feed additives and processing aids, fungistatic and bacteriostatic plant protecting agents and methods of utilizing the same

(75) Inventors: Dennis Tranquil, Jupiter, FL (US); Albert Vladimirovich Kanarsky, Volzhsk (RU); Elizabeth Tranquil, Jupiter, FL (US); Zosya Albertovna Kanarskaya, Kazan (RU); Arthur Tigranovich Kopylov, Engels (RU)

(73) Assignee: Cubena, Inc., Jupiter, FL (US)

(21) Appl. No.: 13/233,021

(22) Filed: Sep. 15, 2011

Related U.S. Application Data
(60) Provisional application No. 61/383,511, filed on Sep. 16, 2010.

(51) Int. Cl. A01N 65/34; A01N 65/44; A01P 1/00; A01N 65/06; A01N 65/00; A01N 65/12; A01N 65/08

(52) U.S. Cl. 424/735; 424/764; 424/750; 424/725; 424/770; 514/22

(57) ABSTRACT

Method is proposed useful to render harmless mycotoxins that contaminate food, animal feed and assist infection of plant hosts by microbial parasites, comprising binding mycotoxins by a novel adsorbent, consisting partially or in full of plant lignocellulosic biomass or isolated biomass components, e.g., acid hydrolysis lignin, enzymatic hydrolysis lignin, coniferous and deciduous wood, bark and needle particles, rice hulls, used coffee grounds, apricot stone shells, almond, walnut, sunflower hulls, cocoa and peanut shells. The materials may be further improved through genetic modification of plants and physicochemical treatment of lignocellulosic biomass, such as micronization. The resulting adsorbent can bind wide range of mycotoxins, including, mycotoxins difficult to bind (Ochratoxin, T-2, Deoxynivalenol, Nivalenol). Ability of porous materials containing lignin to thermally collapse at melting can be used to irreversibly entrap mycotoxins by adsorbing them in a wet system and then closing lignin pore structure under high-temperature treatment, such as drying.

### REFERENCES CITED

U.S. Patent Documents

| | | |
|---|---|---|
| 5,165,946 | November 1992 | Taylor et al. |
| 5,639,492 | June 1997 | Turk et al. |
| 5,935,623 | August 1999 | Alonso-Debolt |
| 6,045,834 | April 2000 | Howes et al. |
| 6,812,380 | November 2004 | Karlovsky et al. |
| 6,827,959 | December 2004 | Schall et al. |
| 20060099322 A1 | May 2006 | Schule et al. |
| 20100189856 A1 | December 2009 | Tranquil et al. |

### Other References

1. G. M. Avantaggiato, M. Solfrizzo, A. Visconti. Recent advances on the use of adsorbent materials for detoxification of Fusarium mycotoxins. Food Additives and Contaminants, 2005, 22, pp. 379-388

2. E. M. Binder, L. M. Tan, L. J. Chin, J. Handl, J. Richard. Worldwide occurrence of mycotoxins in commodities, feeds and feed ingredients. Animal Feed Science and Technology, 2007, 137 (3-4), pp. 265-282

3. G Devegowda, M. V. L. N. Raju, H. V. L. N. Swami. Mycotoxins: novel solutions for their counteraction. Feedstuffs, 1998, 70 (50), pp. 12-17

4. A. Garcia, K. Kalscheur, A. Hippen, and D. Schingoethe. Mycotoxins in Corn Distillers Grains: A concern in ruminants? Brookings, S. D., SDSU College of Agriculture and Biological Sciences publications, Cooperative Extension Service ExEx4038, March 2008, Dairy Science

5. M. B. Genter, W. M. Hagler, J. A. Hansen, B. A. Mowrey, F. T. Jones, M. H. Poore, and L. W. Whitlow. Effects of mycotoxins on the health and productivity of dairy cattle. 2008, North Carolina State University

6. A. Huwig, S. Freimund, O. Käppeli, H. Dutler. Mycotoxin detoxication of animal feed by different adsorbents. Toxicology Letters, 2001, 122 (2), pp. 179-188

7. O. O. M. Iheshiulor, B. O. Esonu, O. K. Chuwuka, A. A. Omede, I. C. Okoli and I. P. Ogbuewu. Effects of mycotoxins in animla nutrition: a review. Asian J. of Animal Sciences, 2011, 5 (1), pp. 19-33 P. Zöllner, B. Mayer-Helm. Trace mycotoxin analysis in complex biological and food matrices by liquid chromatography-atmospheric pressure ionisation mass spectrometry. Journal of Chromatography, 2006, 1136 (2), pp. 123-169

8. M. C. Jewett, G. Hofmann, J. Nielsen. Fungal metabolite analysis in genomics and phenomics. Current Opinion in Biotechnology, 2006, 17 (2), pp. 191-197

9. Y. Liu, F. Walker, B. Hoeglinger and H. Buchenauer. Solvolysis procedures for the determination of bound residues of the mycotoxin deoxynivalenol in Fusarium species infected grain of two winter wheat cultivars preinfected with barley yellow dwarf virus. J. Agric. Food Chem., 2005, 53, p.p. 6864-6869

10. N. Magan, D. Aldred. Post-harvest control strategies: Minimizing mycotoxins in the food chain. International Journal of Food Microbiology, 2007, 119 (1-2), pp. 131-139

11. M. Sabater-Vilar, H. Malekinejad, M. Selman, M. Doelen, J. Fink-Gremmels. In vitro assessment of adsorbents aiming to prevent deoxynivalenol and zearalenone mycotoxicoses. Mycopathologia, 2007, 163 (2), pp. 81-90

12. E. Santin, A. C. Paulillo, L. S. O. Nakagui, A. C. Alessi and A. Maiorka. Evaluation of Yeast Cell Wall on The Performance of Broilers Fed Diets With or Without Mycotoxins. Brazilian Journal of Poultry Science, 2006, 8, No.4, pp. 221-225

13. U.S. Food and Drug Administration, Center for Veterinary Medicine. Nationwide survey of distillers grains for aflatoxins, Nov. 21, 2006

14. L. W. Whitlow. Evaluation of mycotoxin binders. In: Zimmerman, N. G. (ed.) Proc. 4th Mid-Atlantic Nutrition Conference, 2006, University of Maryland, College Park, pp. 132-143

15. F. Wu, G. P. Munkvold. Mycotoxins in Ethanol co-products: Modeling economic impacts on the livestock and management strategies. J. Agric. Food Chem., 2008, 56, pp. 3900-3911

### DESCRIPTION

### Field of the Invention

The present invention addresses the problem of mycotoxin decontamination in food, animal feed and during invasion of agricultural plants by fungal and bacterial parasites by binding mycotoxins via a food or feed additive containing a plant biomass organic component with optionally added conventional non-proprietary mycotoxin binding agents known in the art. As a variant, an additive could be used as a processing aid at a wet stage of the production of food or feed item. The opportunity would then arise to thermally collapse the adsorbent's porous structure and thus irreversibly entrap the adsorbed mycotoxins inside the closed pores. As a result, the mycotoxins will be safely excreted from the digestive tract of humans or agricultural and companion animals without detrimental effects on human health or animal performance and wellbeing. In case of microbial invasion of plants the mycotoxins secreted by the parasite will be bound and thus will be stopped from assisting the invasion. Unlike the Southern climate mycotoxins (aflatoxins, fumonisins, zearalenone), which can be already well-bound by yeast wall and mineral-based adsorbents, the Northern climate mycotoxins (Ochratoxins, T-2 toxin, Deoxynivalenol, Nivalenol) have been proven problematic to bind by methods other than the described in the present invention.

### BACKGROUND OF THE INVENTION

The mycotoxin contamination of feed results in billions of dollars of economic losses to animal husbandry world-wide and in some cases in health damage to human consumers due to transfer of contamination via dairy products, eggs and meats. The key mycotoxigenic moulds in partially dried grains are Penicillium verrucosum, producing ochratoxin (OTA) and Fusarium graminearum and F. sporotrichioides, producing deoxynivalenol (DON), nivalenol (NIV) and T-2 toxin in the damp cool climates of Northern Europe, Siberia, northern US, Canada and Australia. In the South Aspergillus flavus is producing aflatoxins (AF), A. ochraceus—OTA and some Fusarium species are producing fumonisins (FUM) and trichothecenes DON and NIV (Magan, 2007; Binder, 2007; Iheshiulor, 2011).

In animal feed, among the four mycotoxins of particular interest to us, the most detrimental for poultry are: T-2 toxin (maximal concentration in Canada—1, in Slovakia-0.5 and in Ukraine—0.2 mg/kg of feed, mostly for laying hens) and OTA (should be below 0.25 mg/kg of feed, maximum concentration in EU—0.1). DON is not toxic for poultry in concentrations up to 5 mg/kg.

For pigs the most important is zearalenone (analogous to a sex hormone, it reduces the quantity of piglets in a brood and causes characteristic changes of the vulva for saws. The maximum concentration in EU is from 0.1 to 0.25 mg/kg of feed. Also important are: ochratoxin (maximum concentration in Canada is 0.2 mg/kg and in EU—0.05 mg/kg of feed) and DON (causes partial refusal of feed with pigs at higher than 1 mg/kg of feed, which also is a maximal concentration in EU and Canada).

For ruminants the most important are: T-2 toxin (safe level<0.1 mg/kg of feed, maximal concentration in Ukraine—0.25) and ZEN (should be <0.25 mg/kg of feed, maximum concentration in EU—0.5). In Canada for ruminants (calves and dairy cows) the maximum of 1 mg/kg of feed is also imposed for DON, in EU this limit is 2 mg/kg, but effects of DON on ruminants are studied sporadically.

Easy screening for mycotoxin contamination can be provided by a specialized lab equipped with LC/MS, preferably with atmospheric pressure ionization. Up to 30 different toxins can be assayed in a single 30-min run (Jewett, 2006).

Due to the diversity of mycotoxin chemical structures and properties, the mycotoxin binder solutions vary widely (Devegowda, 1998; Huwig 2001; Avantaggiato, 2005; Whitlow, 2006). Commercial binders can be provisionally sorted into sorbents of generation 1 (based on zeolites and clay), generation 2 (based on yeast cell wall) and 2.5 (Mycofix Plus, based on yeast and bacterial biomass plus enzymes).

Under conditions of the present study all commercial adsorbents have demonstrated an insufficient ability to bind all four mycotoxins selected. For example, Mycofix Plus, currently considered to be the most technically advanced binder, adsorbed the four mycotoxins at the extent of 5% 0% 17% and 43% from the start amount (1 mg/l of each) for DON, OTA, T-2 and ZEN, respectively. The last mycotoxin—ZEN—as a rule appears to be the easiest to bind by a variety of adsorbent candidates. Under less stringent binding conditions created for Mycofix Plus (10 times lower mycotoxins load) the binding was considerably improved—to 20%, 26%, 38% and 60%, respectively. Such difference in binding efficiency might indicate that Mycofix Plus works at the upper limit of its binding capacity in forages and its inclusion should be substantially higher, than for other adsorbents to successfully cope with toxicity of grain caused by any of the four mycotoxins tested—DON, OTA, T-2 or ZEN. Affinity of Mycofix Plus to DON, OTA and T-2 is also low, and is only sufficient for ZEN.

Our testing of a widely used mycotoxin binder of the 2nd generation—Mycosorb/MTB-100 from Alltech, USA/Ireland, containing yeast cell wall and mineral clay, was more successful. At high toxin concentrations its adsorbing profile looked as 55-16-6-63, and at low—as 59-34-19-80. Considerable improvements for the second and third number in the profile while lowering the mycotoxins load indicate that Mycosorb has low capacity on OTA and especially T-2. Its affinity to these mycotoxins was rather modest as well.

There is an obvious disconnect between the realistic working range of the T-2 and DON concentrations efficiently adsorbed by the two binders above, especially Mycofix Plus, and the real challenges of mycotoxin contamination faced by the food and animal feed industries. On OTA these commercial binders are rescued from “inferiority complex” by rather low European (but not Russian) maximal limits for pigs (0.05 mg/kg of feed) and poultry (0.1), although 0.5 mg/kg of OTA have not shown any significant effect on broilers (Santin, 2006). However, the range of T-2 contamination significant for animal husbandry and human food lies much higher—around 0.2-1 mg/kg, and that of DON—above 1 mg/kg. Besides this, food and feed components by self-binding provide a partial 9 protecting effect against OTA and ZEN contamination, but to a much lesser extent—against T-2 and DON contamination.

Mineral adsorbents of 1st generation have shown even more limited capabilities to bind the four mycotoxins, compared to Mycosorb. Fungistat GPK (Russia) was found to be the best with a profile of 48-7-1-25 at high mycotoxin load (1 mg/l of each mycotoxin) and with a slightly improved profile at a reduced mycotoxin load (0.1 mg/l). The manufacturer's brochure demonstrates the binding of six mycotoxins by this adsorbent, however not in a mix, but separately and at a concentration of only 0.05 mg/kg. A commercial binder Vita-Toxin Bind (Belgium) at high mycotoxin load demonstrated a profile of 17-18-19-35 in our experiments. Another typical adsorbent of the 1st generation is Toxout (Netherlands) with a profile of 18-13-11-15.

The in-vitro results obtained for commercial mycotoxin binders indicate that there is a room for introduction of a novel product of the next generation that could solve the problems of binding “difficult” mycotoxins and provide enough binding capacity at low inclusion rates. The summary of the in-vitro characterization of mycotoxin binding capacity of the commercial products and novel adsorbent candidates is presented in Tables 1, 2 and 3.

As a recent development, the DDGS (Distiller's Dried Grain with Solubles) from fuel ethanol industry contains a significant amount of mycotoxins, especially taking into account their 3-fold concentration from maize grain to pot solids (U.S. Food and Drug Administration , 2006). The difficult to bind varieties of mycotoxins are also concentrated 3-fold, but cannot be alleviated by yeast-based DDGS components or specially added binders. Meanwhile, the negative effect of feeding DDGS with current mycotoxin levels to pigs only was calculated nationally at $2-8 million p.a. at current penetration of DDGS into swine feed and $30-290 million at inclusion of DDGS into all swine feed at 200 kg/ton (Wu , 2008).

Feeding DDGS and WDG to ruminants without control of DON already leads to substantial economic losses. The majority of distiller's grain is consumed by cattle. According to field observations, when DON concentrations are higher than 0.5 ppm, milk yield is reduced by 25 pounds (Genter, 2008). A maximum of 7.7 ppm and an average of 3.6 ppm of DON were reported for 54 samples of DDGS tested (accumulated crop years: May 1, 2000 through Apr. 30, 2007). The respective concentrations for Wet Distiller's Grain were 4.3 and 1.9 ppm (Garcia, 2008), implying a reduced milk yield. Again, these losses cannot be alleviated using conventional yeast cell wall-based mycotoxin binders, saying nothing of earlier products.

Mycotoxins produced by parasitic microbes play an important role during colonization of the plant host. As a protection, the plants produce organic compounds capable of conjugating the mycotoxins with more or less success. This capability can be expanded by plant selection aimed at improving the plant resilience to mycoses (Liu, 2005). However using exogeneous mycotoxin-binding agents, such as specialized biomass components from other plants, to provide more resistance to the plan host has not been yet proposed by other authors.

### SUMMARY OF THE INVENTION

A primary objective of the present invention is to provide a method for the adsorption of mycotoxins in human food, common animal feedstuffs and for protection against invasion of plants by microbial parasites. The method utilizes a combination of one or more selected plant biomass components and optional conventional non-proprietary mycotoxin adsorbing component known in the art.

The plant biomass components include, but are not limited to: acid hydrolysis lignin, enzymatic hydrolysis lignin, rice hulls, cocoa shells, used coffee grounds, apricot stone shells, almond, walnut and peanut shells, coniferous wood, bark and needle particles, deciduous wood and bark particles.

Yet another objective of the present invention is to provide a composition, as described above, which may render harmless a wider range of multiple mycotoxins, with specific emphasis on mycotoxins typical for Northern climates (Ochratoxin, T-2, Deoxynivalenol, Nivalenol), currently poorly handled by the existing mycotoxin adsorbents, in addition to mycotoxins typical for Southern climates (Aflatoxins, FumonisinsUM, Zearalenone), that are handled satisfactorily by the current generation of mycotoxin binders.

Additional objectives, advantages and other novel features of the invention will be set forth in part in the description that follows and in part will become apparent to those skilled in the art upon examination of the following or may be learned with the practice of the invention. The objects and advantages of the invention may be realized and obtained via the instrumentalities and combinations pointed out in the appended claims.

To achieve the foregoing and other objectives, and in accordance with the purposes of the present invention as described herein, a novel method is described for binding mycotoxins present in food and animal feeds, components to produce food and animal feeds and during the fungal invasion of agricultural and horticultural plants. In a preferred embodiment, the invention provides a method and a composition encompassing one or more of novel selected plant biomass components and a optional conventional non-proprietary mycotoxin adsorbing component or components known in the art. The plant components can be produced by several methods and additionally modified to generate maximal surface area, e.g., by milling (micronization). The non-proprietary mycotoxin binding components, selected from classes of natural clays, artificial clays, organic polymers, activated charcoal, yeast cell wall polysaccharides, etc., are readily available commercially.

The compositions provided by the invention can be fed to any agricultural, companion and wild animal including, but not limited to, avian, bovine, porcine, equine, ovine, caprine, canine, feline and aquaculture species. The composition can be also used as a functional food additive. When admixed with food, feed, used as a processing aid or fed as a supplement, the compositions decrease intestinal absorption of the mycotoxins by the affected animal, thereby improving performance and health, and reducing the incidence of mycotoxin-associated diseases. These compositions have an increased mycotoxin-binding capacity and expanded mycotoxin type range in comparison to conventional mycotoxin binders.

Certain discovered plant biomass components can thermally collapse their pores after mycotoxins have been absorbed, allowing for possible use of these components as a processing aid. A binding component with low melting point, such as 95° C. for lignin, can be added at a wet stage of processing to adsorb mycotoxins. Sometime after the binding stage, e.g., during food/feed product drying, the adsorbent particles are partially melted to close the pores and irreversibly entrap the mycotoxins inside. The approach is especially effective during production of DDG and DDGS.

### DETAILED DESCRIPTION OF THE INVENTION

The present invention is based upon a surprising discovery that selected types of plant biomass can have an unexpected binding effect on mycotoxins of Northern origin present in animal feeds, foods and food ingredients and important during invasion of plants by microbial parasites. Most of these “Northern” mycotoxins are known to be difficult to sequester otherwise. Thus, the invention provides a method and a composition for binding mycotoxins utilizing a combination of novel plant ligno-cellulosic materials, optionally modified, and non-proprietary mycotoxin binding agents known in the art.

A number of candidates for mycotoxin binders have been tested in-vitro in a model system to provide a selection of components for various versions of a mycotoxin adsorbent composition of the 3rd generation, results being presented in Tables 1-3. Conditions included adsorption of four “Northern” mycotoxins, difficult to bind with the current generation of commercial adsorbents—DON (=vomitoxin), ochratoxin (OTA), T-2 and zearalenone (ZEN)—from an aqueous solution, pH 6.5 (0.1 M Na-phosphate buffer), at 37° C. within an hour by a 0.5% suspension of the adsorbent candidate. Concentration of each mycotoxin in the mix was chosen at 1 mg/L (in sum—4.0 mg/L). Because several commercial sorbents have shown low capacity under these conditions, as the second step these sorbents also have been tested at a mycotoxin concentration 10 times lower—0.1 mg/L (total of 0.4 mg/L for 4 mycotoxins). The behavior of “Southern” mycotoxins, i.e., aflatoxins and fumonisins, at this stage was not investigated, since binding of “Southern” toxins in forages and food is trivial and involves adding yeast cell wall into the adsorbent composition.

Mycotoxin content in the model aqueous solution was measured using HPLC/MS/MS on a C-8 column eluted by a gradient of formiate buffer->acetonitrile. Under these HPLC conditions mycotoxins are eluted from the column in the following sequence: DON-OTA-T-2-ZEN.

TABLE 1
Binding of DON, OTA, T-2 and ZEN from a mixture of four mycotoxins

| | % of mycotoxin adsorbed from a | | | |
|---|---|---|---|---|
| Adsorbent candidate, 5 g/L, pH 6.5, | mixture of 4 toxins, 1 mg/L each | | | |
| 37° C., 1 hour | DON | OTA | T-2 | ZEA |
| Commercial mycotoxin binders | | | | |
| Mycofix Plus (Biomin, Austria) | 4.8 | 0.1 | 17.2 | 42.9 |
| Mycosorb (Alltech, Ireland) | 55.3 | 16.1 | 6.1 | 62.7 |
| Norditox (Cubena, USA) | 50.2 | 1.5 | 0.0 | 53.2 |
| Fungistat GPK (Alest, Russia) | 48.5 | 6.9 | 0.7 | 25.2 |
| Vita-Toxin Bind (Vitafor, Belgium) | 16.8 | 18.2 | 19.2 | 35.4 |
| Fungistat K (Alest, Russia) | 7.5 | 0.0 | 0.0 | 13.0 |
| Toxout (DaAlestion, Netherlands) | 18.5 | 13.1 | 10.7 | 15.1 |
| Forestry-based binder candidates | | | | |
| Acid hydrolysis lignin, alkali-extracted, 500 mkm | 16.3 | 23.8 | 28.4 | 91.5 |
| Acid hydrolysis lignin, milled to 200 mkm | 24.2 | 36.9 | 41.1 | 95.0 |
| Acid hydrolysis lignin milled to 100 mkm (coarse) | 23.3 | 43.4 | 52.6 | 98.1 |
| Acid hydrolysis lignin milled to 30 mkm (medium) | 13.3 | 25.6 | 27.7 | 93.8 |
| Acid hydrolysis lignin milled to 20 mkm (fine) | 11.7 | 27.0 | 32.2 | 95.8 |
| Acid hydrolysis lignin, micronized to 5 mkm | 28.5 | 24.2 | 39.9 | 97.0 |
| Lignin residue after enzymatic hydrolysis of | 0.0 | 5.9 | 0.0 | 77.5 |
| micronized aspen wood | | | | |
| Wood, aspen (Pópulus trémula), micronized to 5 mkm | 7.4 | 14.1 | 10.0 | 68.1 |
| Wood, Scots pine (Pinus sylvestris), micronized to 5 mkm | 10.6 | 5.5 | 90.6 | 62.1 |
| Wood, Scots pine, de-pitched and micronized to 5 mkm | 5.8 | 7.4 | 90.5 | 66.5 |
| Bark, Norway spruce (Picea abies), milled to 20 mkm | 39.2 | 8.7 | 13.3 | 76.8 |
| Wood, Norway spruce (Picea abies), milled to 20 mkm | 25.7 | 4.9 | 4.6 | 63.9 |
| Wood, Scots pine (Pinus sylvestris), milled to 20 mkm | 26.7 | 5.3 | 2.7 | 57.6 |
| Needles, Scots pine (Pinus sylvestris), milled to 20 mkm | 51.1 | 7.8 | 9.8 | 70.7 |
| Peat, micronized to 5 mkm | 2.3 | 20.3 | 5.5 | 88.0 |
| Agriculture-based binder candidates | | | | |
| Rice hulls, micronized to 40 mkm | 27.0 | 23.2 | 17.7 | 63.2 |
| Cocoa shells, micronized to 40 mkm | 59.4 | 15.8 | 17.8 | 52.5 |
| Coffee grounds | 6.9 | 7.7 | 3.8 | 66.6 |
| Apricot stones, micronized to 5 mkm | 32.9 | 10.8 | 11.1 | 64.5 |
| Sunflower hulls, micronized | 28.5 | 2.6 | 0.7 | 31.2 |
| Lignin after acid hydrolysis of sunflower hulls | 3.4 | 16.8 | 11.1 | 78.1 |
| Mineral candidates | | | | |
| Zeolite, fine powder | 13.6 | 5.1 | 13.7 | 18.7 |
| Zeolite, crushed | 14.7 | 2.4 | 11.9 | 15.3 |

TABLE 2
Comparison of reduced mycotoxin load (0.1 mg/L of each mycotoxin versus 1 mg/L)
on the performance of commercial adsorbents and novel adsorbent candidates

| | % of mycotoxin adsorbed from a mixture | | | |
|---|---|---|---|---|
| Adsorbent candidate, 5 g/L, pH 6.5, | of 4 toxins, 1 mg/L or 0.1 mg/L each | | | |
| 37° C., 1 hour | DON | OTA | T-2 | ZEA |
| Mycofix Plus (Biomin, Austria), 1 mg/L of each toxin | 4.8 | 0.1 | 17.2 | 42.9 |
| Same, 0.1 mg/L of each toxin | 19.9 | 26.4 | 37.7 | 59.6 |
| Mycosorb (Alltech, Ireland), 1 mg/L of each toxin | 55.3 | 16.1 | 6.1 | 62.7 |
| Same, 0.1 mg/L of each toxin | 59.5 | 34.3 | 18.9 | 79.6 |
| Norditox (Cubena, USA), 1 mg/L of each toxin | 50.2 | 1.5 | 0.0 | 53.2 |
| Same, 0.1 mg/L of each toxin | 56.2 | 31.4 | 8.8 | 80.0 |
| Fungistat GPK (Alest, Russia), 1 mg/L of each toxin | 48.5 | 6.9 | 0.7 | 25.2 |
| Same, 0.1 mg/L of each toxin | 49.8 | 12.6 | 2.1 | 31.0 |
| Fungistat K (Alest, Russia), 1 mg/L of each toxin | 7.5 | 0.0 | 0.0 | 13.0 |
| Same, 0.1 mg/L of each toxin | 5.4 | 15.0 | 8.1 | 18.6 |
| Hydrolysis lignin, milled to 200 mkm, 1 mg/L of each toxin | 24.2 | 36.9 | 41.1 | 95.0 |
| Same, 0.1 mg/L of each toxin | 29.1 | 56.0 | 59.8 | 98.8 |
| Hydrolysis lignin milled to 100 mkm, 1 mg/L of each toxin | 23.3 | 43.4 | 52.6 | 98.1 |
| Same, 0.1 mg/L of each toxin | 21.3 | 63.4 | 65.3 | 98.9 |
| Hydrolysis lignin, alkali-extracted, 1 mg/L of each toxin | 16.3 | 23.8 | 28.4 | 91.5 |
| Same, 0.1 mg/L of each toxin | 18.1 | 48.0 | 41.6 | 93.2 |
| Coffee grounds, 1 mg/L of each toxin | 6.9 | 7.7 | 3.8 | 66.6 |
| Same, 0.1 mg/L of each toxin | 8.7 | 26.3 | 3.0 | 72.7 |
| Wood, Scots pine (Pinus sylvestris), micronized to 5 mkm, | 10.6 | 5.5 | 90.6 | 62.1 |
| 1 mg/L of each toxin | | | | |
| Same, 0.1 mg/L of each toxin | 12.6 | 24.7 | 90.3 | 82.4 |
| Wood, Scots pine, de-pitched and micronized to 5 mkm, 1 mg/L | 5.8 | 7.4 | 90.5 | 66.5 |
| of each toxin | | | | |
| Same, 0.1 mg/L of each toxin | 6.1 | 29.5 | 90.9 | 80.6 |
| Sunflower hulls, micronized, 1 mg/L of each toxin | 28.5 | 2.6 | 0.7 | 31.2 |
| Same, 0.1 mg/L of each toxin | 31.9 | 28.3 | 4.9 | 48.7 |
| Lignin after acid hydrolysis of sunflower hulls, 1 mg/L of | 3.4 | 16.8 | 11.1 | 78.1 |
| each toxin | | | | |
| Same, 0.1 mg/L of each toxin | 5.5 | 43.7 | 40.3 | 87.8 |

TABLE 3
Effect of the surface modification of the adsorbent candidate
by a bi-functional protein - Trichoderma cellulase.

| | % of mycotoxin adsorbed from a | | | |
|---|---|---|---|---|
| Adsorbent candidate, 5 g/L, pH 6.5, | mixture of 4 toxins, 1 mg/L each | | | |
| 37° C., 1 hour | DON | OTA | T-2 | ZEA |
| Acid hydrolysis lignin, milled | 23.3 | 43.4 | 52.6 | 98.1 |
| to 100 mkm | | | | |
| Same + Trichoderma cellulase | 33.3 | 44.4 | 44.5 | 97.5 |
| enzyme (10% w/w) | | | | |
| Rice hulls, micronized to 5 mkm | 27.0 | 23.2 | 17.7 | 63.2 |
| Same + Trichoderma cellulase | 26.5 | 10.9 | 2.7 | 59.0 |
| enzyme (10% w/w) | | | | |
| Wood, aspen (Pópulus trémula), | 7.4 | 14.1 | 10.0 | 68.1 |
| micronized to 5 mkm | | | | |
| Same + Trichoderma cellulase | 12.8 | 8.9 | 0.9 | 65.2 |
| enzyme (10% w/w) | | | | |
| Lignin residue after enzymatic | 0.0 | 5.9 | 0.0 | 77.5 |
| hydrolysis of micronized aspen wood | | | | |
| Same + Trichoderma cellulase | 25.0 | 16.5 | 6.1 | 84.5 |
| enzyme (10% w/w) | | | | |

### DON

From the commercial standpoint binding of DON (vomitoxin) is important mainly for pig growers, the economically significant DON contamination levels being around 1 mg/kg feed.

The best binder of DON (59% bound, which is better than that for Mycosorb and Mycofix Plus) was found to be cocoa shells, ground to 40 micron (Table 1). The binding capacity of cocoa shells could be additionally improved if the material is ground to 5-10 micron, using for example an orbital mill.

Another good candidate to adsorb DON are sunflower hulls crushed to 40 microns (28% bound) and ground rice hulls, 5 microns (27% bound).

Acid hydrolysis lignin from wood adsorbed DON at 20-28%, the best being a sample of dry lignin, micronized to 5 mkm using an orbital mill. Addition of fungal cellulase to modify the surface of lignin by a bipolar protein layer in a dosage of 0.5 g/l ( 1/10 of the adsorbent amount) improved the adsorption of DON (Table 3). For example lignin ground to 100 mkm using an impeller mill adsorbed 23% of initial DON without surface modification by cellulase and 33% of initial DON—with enzyme. DON adsorption by lignin left after enzymatic hydrolysis of micronized to 5 mkm aspen has improved cellulase adsorption from 0 to 25%. As DON is not detrimental for broilers, addition of surface modifying protein, such as Trichoderma cellulase, can be recommended only for mycotoxin binder compositions intended for pigs.

In essence, for neutralizing DON we suggest including into a mycotoxin binder composition of the milled or micronized cocoa shells.

### Ochratoxin

Acid hydrolysis lignin from wood considerably exceeds commercial sorbents in the capability to bind this toxin. For example, lignin milled to 100 mkm using an impeller mill adsorbed 43% of initial OTA and 63% of initial OTA, respectively at high load (1 mg/L of OTA) and low load (0.1 mg/L of OTA). For comparison: Mycosorb bound, respectively, only 16 and 34% of initial OTA, and Mycofix—even less than that.

Acid hydrolysis lignin produced from sunflower hulls was also shown to be an affective binder for OTA: 17 and 44% of initial, respectively.

### T-2

Acid hydrolysis lignin from wood was shown in our screening experiments to be a considerably better binder of T-2 compared to the existing commercial adsorbents. Lignin milled to 100 mkm using an impeller mill adsorbed 53 and 65% of T-2, respectively, at high T-2 load and at low load (Tables 1 and 2). For comparison: Mycofix Plus adsorbed only 17 and 38% of initial T-2, respectively, and Mycosorb—even less.

Acid hydrolysis lignin produced from sunflower hulls was shown to be a less affective binder for T-2: 11 and 40% of initial T-2, respectively.

Surface modification of the binder by Trichoderma cellulase decreased the T-2 adsorption for all binder candidates, for example, for hydrolysis lignin from wood—from 53% to 44% (Table 3).

Surprisingly, micronized pine wood (5 mkm) was found by us to be an extremely good adsorbent for T-2 (Tables 1 and 2). Both with pitch intact and pitch removed by solvent extraction, the material adsorbs 90% of initial T-2 both at low, and at high mycotoxin load (Tables 1 and 2). Micronized aspen wood produced in a similar way did not adsorb any significant T-2 quantities.

In essence, acid hydrolysis lignin from wood, especially milled at low temperatures to produce maximal surface area, far exceeds all known commercial products in binding this most difficult toxin. If a more complete binding of T-2 is desirable, 25% -100% of micronized pine wood can be included into the mycotoxin binder composition.

### Zearalenone

ZEN is the most hydrophobic of all four mycotoxins and therefore is readily adsorbed by a number of binding candidates from an aqueous solution. Nevertheless, even in such an easy mission Mycofix Plus and Mycosorb have managed to demonstrate rather modest results in our in-vitro testing. Mycofix Plus adsorbed only 43 and 60% of initial ZEN, respectively, at high and low mycotoxin load, and Mycosorb - respectively 63 and 80%.

For comparison, many tested candidates surpassed Mycofix and Mycosorb in these capabilities: acid lignin milled to 100 mkm (98 and 99%), lignin from sunflower hulls (78 and 88%), even micronized pine wood (62 and 82%), micronized rice hulls and especially micronized peat (Tables 1 and 2). Micronized aspen wood and its lignin residue after enzymatic hydrolysis performed on ZEN comparably to micronized pine wood. Modification of the binder surface by bipolar fungal cellulase layer improved the ZEN adsorption only for lignin after enzymatic hydrolysis of micronized aspen (Table 3), in all other cases the adsorbents were effective enough without this modifier.

Mineral adsorbents—Fungistat (Russia), Toxout (Netherlands), Vita-Toxin Bind (Belgium) were found to be ineffective for binding ZEN under the conditions of screening experiments (Table 1).

In essence, hydrolysis lignin, without major modifications, save micronization at low temperatures, can be an effective ZEN adsorbent.

In another embodiment of the invention, the mycotoxin binding capacity of the modified plant biomass is pre-programmed and enhanced in the initial plant material using the classical plant hybridization/selection programs and plant genetic engineering tools known in the art. The direction of introducing novel treats into plants is generally opposing to the course taken in the cellulosic ethanol program. While in the cellulosic ethanol program the plant biomass is transformed to decrease the lignin content and the degree of cellulose crystallinity, the treats benefiting the mycotoxin adsorption include increase in lignin content, anion-exchange groups (such as amino-groups) and a crystalline cellulosic backbone strength.

The plant material selected can be subjected to a number of mechanical and chemical treatment steps, aimed at increasing the hemicellulose and lignin content, specific area of the resulting adsorbent and hydrophobicity of the surface.

One of the treatments of the plant material, according to the present invention, is aimed at increasing the mycotoxin binding capability by using preliminary mechanical pulverizing (micronization) yielding a low and uniform particle size.

In yet another embodiment of the present invention the surface of lignocellulosic component is modified by adsorbing an ambivalent protein, having affinity to the lignocellulose surface, on one hand, and to mycotoxins, on the other. For example, endoglucanases of the microbial cellulase complex, microbial beta-glucanases and other hemicellulases, amylases, proteases and oxido-reductases of micromycetes, actinomycetes and bacteria can be used as ambivalent proteins. An important requirement for the ambivalent protein is to have a cellulose- or lignin-binding domain in its structure.

In the preferred embodiment of the present invention, the resulting plant mycotoxin adsorbing components become the core ingredients, enabling a successful expansion of the bound mycotoxin range, including those difficult to bind mycotoxins typical for Northern climates (OTA, T-2, DON, NIV). Other ingredients, providing affinity towards more easily bound mycotoxins typical for Southern climates (AF, FUM, ZEN) can be included at a rate of 10-90% (w/w), chosen from conventional non-proprietary binding agents known in the art and used in the industry, such as, but not limited to: natural clays, man-made clays, organic polymers and yeast cell wall components.

In a preferred embodiment, the composition of the present invention comprises between about 10% and about 90% of modified plant ligno-cellulose components, and between about 90% and about 10% of a conventional non-proprietary mycotoxin binding agents. A preferred composition of the invention comprises from between about 25% to about 70% of modified plant ligno-cellulose components, and between about 75% and about 30% of a conventional non-proprietary mycotoxin binding agents. An especially preferred embodiment of the invention comprises from between about 50% to about 60% of modified plant ligno-cellulose components, and between about 50% and about 40% of a conventional non-proprietary mycotoxin binding agents. The preferred physical form of the invention is a dry, free-flowing powder, micro-granulate or a paste suitable for direct inclusion into animal feeds and human foods, injection into food, feed and ethanol production processes or for use as a fungistatic or bacteriostatic in plant protection.

The compositions provided by the present invention can be added to any commercially available feedstuffs for livestock or companion animals including, but not limited to, premixes, concentrates and pelleted concentrates. The composition provided by the present invention may be incorporated directly into commercially available mashed and pelleted feeds or fed supplementally to commercially available feeds. When incorporated directly into animal feeds, the present invention may be added to such feeds in amounts ranging from 0.2 to about 5 kilograms per ton of feed. In a preferred composition, the invention is added to feeds in amounts ranging from 0.5 to about 2 kilograms per ton of feed. In an especially preferred composition, the invention is added to feeds in amounts ranging from 1 to 2 kilograms per ton of feed. The composition contained in the present invention may be fed to any animal, including but not limited to, avian, bovine, porcine, equine, ovine, caprine, canine, feline and aquaculture species.

The methods of the invention comprise increasing binding and removal of mycotoxins from animal feedstuffs, including, but not limited to, aflatoxins, zearalenone, vomitoxin, fumonisins, T2 toxin and ochratoxin, thereby increasing safety and nutritional value of the feed and the overall health and performance of the animal. The compositions of the invention are sufficiently effective in increasing binding of OTA, T-2, DON and NIV, compared to binding obtained with the current generation of mycotoxin binders, in addition to binding aflatoxins, zearalenone, and fumonisin, where the current mycotoxin binders already excel.

The proposed methods of binding of an extended range of mycotoxins are especially useful for alleviating the effect of mycotoxin concentration while fermenting grains during ethanol and beer fermentations. The resulting Wet Distiller's Grain and Dried Distiller's Grain, including DDGS, have on average a 3-fold increase in mycotoxin content compared to initial materials. While aflatoxins can be bound by yeast present in the spent grains and by conventional adsorbents based on yeast cell wall, DON and T-2 are discovered in WDG and DDGS on a regular basis and at elevated levels and could only be controlled by a solution proposed in the present invention.

To decontaminate DDG or DDGs, the compositions can be added as processing aids at any wet stage of ethanol production prior to DDG drying. A property of hydrolysis lignin to thermally collapse its pores during any processing stage involving high heat above 95° C., such as DDG drying, can be used to irreversibly trap mycotoxins within the lignin.

The composition contained in the present invention may be added to mycotoxin-contaminated animal feedstuffs in amounts from about 0.02% to 0.5% by weight of feed. In a preferred embodiment, the composition is added to mycotoxin-contaminated animal feedstuffs in amounts from about 0.03% to 0.3% by weight of feed. In an especially preferred embodiment, the invention is added to mycotoxin-contaminated animal feedstuffs in amounts from about 0.1% to 0.2% by weight of feed.

Alternatively, the composition contained in the present invention may be directly fed to animals as a supplement in amounts ranging from 2.0 to 20 grams per animal per day. An especially preferred embodiment comprises feeding the composition contained in the present invention to animals in amounts ranging from 5 to 15 grams per animal per day, depending on the animal species, size of the animal and the type of feedstuff to which the composition is to be added.

### EXAMPLES

The following examples are intended to be illustrative of the invention, and are not to be considered restrictive of the scope of the invention as otherwise described herein.

### Example 1

Any novel candidate from Table 1 can be used as a mycotoxin binder either alone or in combination with other novel candidates or non-proprietary binding agents known in the art, depending on the expected pattern of mycotoxin contamination. In particular, micronized pine wood (5 mkm) can be used if mainly T-2 contamination is expected, or micronized cocoa shells (5-40 mkm), if mainly DON contamination is expected, or combination of the two if both DON and T-2 are present.

### Example 2

Hydrolysis lignin was excavated from an abandoned landfill, where only lignin was deposited. The age of the deposit was estimated at 10 years, which gives some assurance that neither sulfates (especially detrimental for swine diets) nor extractables (such as furfural) are present. The moisture content was reduced from 60 to 8% by drying in a natural gas-heated furnace combined with preliminary milling, classifying and foreign object removal, the outlet temperature not exceeding 60° C. The resulting dry lignin was milled using an impeller mill to an average particle size of 40 microns and mixed with yeast cell wall (commercial product) at a ration 60-40 w/w. The resulting mixture was micro-encapsulated in a Glatt fluid bed granulator using Lactose as a binder. The resulting product was tested for in-vitro mycotoxin binding capacity in comparison to the best commercial binders—Mycofix Plus and Mycosorb. The results are presented in Table 4.

TABLE 4
Comparison of the novel 3rd generation mycotoxin binder to
the existing commercial products in in-vitro experiment with
3 difficult to bind “Northern” mycotoxins and zearalenone.

| | % of mycotoxin adsorbed from a mixture | | | |
|---|---|---|---|---|
| Adsorbent composition, 5 g/l, pH 6.5, | of 4 toxins, 1 mg/l or 0.1 mg/l each | | | |
| 37° C., 1 hour | DON | OTA | T-2 | ZEA |

Novel Generation 3 Mycotoxin Binder

| | | | | |
|---|---|---|---|---|
| Product composition, as described in | 45.4 | 38.8 | 71.6 | 95.2 |
| Example 2, 1 mg/l of each toxin | | | | |
| Same, 0.1 mg/l of each toxin | 48.0 | 43.9 | 75.4 | 92.1 |

Generation 2½ Mycotoxin Binder

| | | | | |
|---|---|---|---|---|
| Mycofix Plus (Biomin, Austria), 1 mg/l of | 4.8 | 0.1 | 17.2 | 42.9 |
| each toxin | | | | |
| Same, 0.1 mg/l of each toxin | 19.9 | 26.4 | 37.7 | 59.6 |

Generation 2 Mycotoxin Binders

| | | | | |
|---|---|---|---|---|
| Mycosorb (Alltech, Ireland), 1 mg/l of each | 55.3 | 16.1 | 6.1 | 62.7 |
| toxin | | | | |
| Same, 0.1 mg/l of each toxin | 59.5 | 34.3 | 18.9 | 79.6 |
| Fungistat GPK (Alest, Russia), 1 mg/l of | 48.5 | 6.9 | 0.7 | 25.2 |
| each toxin | | | | |
| Same, 0.1 mg/l of each toxin | 49.8 | 12.6 | 2.1 | 31.0 |

Generation 1 Mycotoxin Binder

| | | | | |
|---|---|---|---|---|
| Fungistat K (Alest, Russia), 1 mg/l of each | 7.5 | 0.0 | 0.0 | 13.0 |
| toxin | | | | |
| Same, 0.1 mg/l of each toxin | 5.4 | 15.0 | 8.1 | 18.6 |

### Example 3

Micronized lignin was obtained as described in example 2 and used as a thermally collapsible mycotoxin trap under the conditions modeling manufacturing and drying of the Distiller's Grain. Adsorption of T-2 toxin was conducted during its incubation at initial concentration of 5 mg/L with a suspension of micronized lignin (5 g/L) at pH 2.0 and 37-39° C. for 60 minutes. The suspension was converted into solids by evaporating water till constant weight. The dried residue was thermally treated at a range of temperatures from 20 to 150° C. The thermally processed lignin was subjected to T-2 toxin extraction using 3 batches of chloroform. The chloroform extracts were pooled and dried using a rotary evaporator. Quantitative assay of the extracted T-2 toxin was conducted using thin layer chromatography supplemented by bio-autographic detection using a yeast culture.

The results illustrating the degree of irreversible binding of T-2 toxin by micronized lignin subjected to various degrees of thermal processing are presented in Table 5.

TABLE 5
Influence of temperature of thermal processing of lignin
after initial binding of T-2 toxin on the degree of
the subsequent extractability of T-2 by chloroform and,
accordingly, % of irreversible binding of T-2.

| | Temperature of | Extraction of T-2 | Irreversible T-2 |
|---|---|---|---|
| Initial binding | thermal treat- | with chloroform | binding promoted |
| of T-2 toxin by | ment after | after thermal | by thermal |
| micronized lig- | initial T-2 | treatment, % of | treatment, % of |
| nin at pH 2.0, % | binding, ° C. | total initial T-2 | total initial T-2 |
| 72.0 | 20 | 17.0 | 55.0 |
| | 50 | 6.0 | 66.0 |
| | 100 | 3.0 | 69.0 |
| | 150 | 2.0 | 70.0 |

### Example 4

The T-2 adsorption was tested at its concentration in water of 5 mg/L using as a binder a suspension of Dried Distiller's Grain at 5 g/L, pH 2.0 and 37-39° C. for 60 minutes. DDG from wheat ethanol fermentation was used, dried to constant weight. After the adsorption stage moisture was removed by evaporation up to constant weight and the dried residue was treated at a range of high temperatures imitating conditions of Distiller's Grain drying.

The T-2 detection, initial adsorption and sample processing, including extraction with chloroform, was conducted as described in Example 3, except for a suspension of DDG alone and DDG+micronized lignin (9:1 by dry weight) being used as adsorbents.

The results demonstrate (Table 6) that 35% of initial T-2 toxin is reversibly bound by Distiller's Grain components even in the absence of lignin binder. However this share of T-2 is easily extracted by chloroform, even if a thermal treatment is applied between the stages of T-2 adsorption and chloroform extraction (imitating the drying stage), regardless of treatment temperature. In contrast, the other 65% of initial T-2 attributed to binding by lignin can be bound irreversibly and not subjected to extraction even by a harsh organic solvent, especially if a high-temperature drying stage is introduced between T-2 initial binding and chloroform extraction. Hence we attribute the effect of irreversible binding to melting of lignin pores and entrapment of the bound T-2 within the collapsed lignin porous structure.

For Examples 3 and 4 it should be noted that extraction with chloroform presents an extreme case of an attempt to release back the bound T-2 toxin. In real life applications much milder conditions of desorption are expected. Nevertheless, the thermal treatment of the lignin adsorbent made it possible to render the T-2 already bound practically unextractable even by chloroform, provided the temperature is high enough to melt the lignin and collapse its pores.

TABLE 6
Comparison of T-2 toxin extractability by chloroform after drying
of Distiller's Grain at a range of temperatures, with micronized
lignin being absent or present (10% of total solids) before the
initial T-2 binding. Decrease in T-2 extractability with temperature
indicates irreversible binding of T-2 by thermally collapsed lignin
structure, but not by Distiller's Grain alone.

| Drying temperature | Extraction of T-2 | Extraction of T-2 by |
|---|---|---|
| for Distiller's Grain | by chloroform after | chloroform after drying |
| or Distiller's Grain | drying of Distiller's | of Distiller's Grain |
| with lignin, ° C., after | Grain, % of initial | with lignin (9:1), % of |
| application of T-2 toxin | introduced T-2 | initial introduced T-2 |
| 20 | 65 | 50 |
| 50 | 65 | 20 |
| 100 | 65 | 15 |
| 150 | 65 | 10 |

1. A composition for adsorbing and thereby rendering harmless a wide spectrum of mycotoxins, present in food, animal feed and detrimental during parasitic microbial invasion of plants, including mycotoxins that are difficult to bind (such as ochratoxin, deoxynivalenol, T-2), comprising 10-90% of modified plant ligno-polysaccharides and optionally 90-10% of conventional mycotoxin binding components, where the ligno-polysaccharide components are produced from agricultural by-products, such as, but not limited to: sunflower hulls, rice hulls; or from food industry by-products, such as, but not limited to: cocoa shells, apricot stones, coffee grounds ; or from timber, Pulp & Paper or alternative energy industry by-products, such as, but not limited to: acid hydrolysis lignin, enzymatic hydrolysis lignin, coniferous wood particles, coniferous bark and needle particles, deciduous wood particles, peat particles, while the plant biomass could be optionally enhanced in mycotoxin-binding capabilities prior to growing by introducing genetic traits into plants using methods of classical plant hybridization/selection programs and/or genetic engineering of plants known in the art or enhanced after harvesting by physico-chemical treatment, such as micron milling or surface modification by an ambivalent protein.

2. Method of plant protection against mycoses and bacterioses, decontamination of food and animal feed containing mycotoxins typical for both Northern (such as ochratoxin, deoxynivalenol, T-2) and Southern climates (such as aflatoxins, nivalenol, zearalenone and fumonisins), when the effective amount of the mycotoxin-binding composition is used as a contact fungistatic or bacteriostatic agent in plant protection, processing aid at one of the wet stages of food or feed production or food and feed additive and when optionally the mycotoxin binding composition is capable of thermally collapsing its pores during a high temperature processing sep, such as drying of DDG, thus irreversible entrapping the adsorbed mycotoxins within the adsorbent structure.

3. Method of decontamination of animal feed containing mycotoxins typical for both Northern (such as ochratoxin, deoxynivalenol, T-2) and Southern climates (such as aflatoxins, nivalenol, zearalenone and fumonisins) intended for agricultural or companion animals belonging to the group of invertebrate and vertebrate aquatic, avian and mammalian (such as bovine, porcine, equine, ovine, caprine, canine, feline) species, when the effective amount of the mycotoxin-binding composition comprises from between about 0.02% to between about 0.5% by weight of the animal's daily feed ration.
